(19) United States
(12) Patent Application Publication
(10) Pub. No.: US 2017/0364819 A1
(43) Pub. Date: Dec. 21, 2017

(54) ROOT CAUSE ANALYSIS IN A COMMUNICATION NETWORK VIA PROBABILISTIC NETWORK STRUCTURE

(71) Applicant: Futurewei Technologies, Inc., Plano, TX (US)

(72) Inventor: Kai Yang, Bridgewater, NJ (US)

(73) Assignee: Futurewei Technologies, Inc., Plano, TX (US)

(21) Appl. No.: 15/186,346

(22) Filed: Jun. 17, 2016

(51) Int. Cl. G06N 7/00; H04L 12/24

(52) U.S. Cl. CPC G06N 7/005; H04L 41/16

(57) ABSTRACT

The disclosure relates to technology for determining a root cause of anomalous behaviors in networks. First indicators (KQIs) are categorized into first groups (states) and second indicators (KPIs) are categorized into second groups. A conditional probability is estimated by calculating a probability that the second indicators will result in degradation of the first indicators based on historical data using association rule learning. The second indicators having the conditional probability associated with degradation of the first indicators are mapped to a corresponding one of the first groups in a probabilistic network structure based on a detected degradation of the first indicators in the historical data. Then it is determined whether the second indicators mapped to the corresponding first groups satisfy a threshold when degradation of the first indicators is detected, and each of the second indicators resulting in degradation of the first indicator are ranked according to a corresponding conditional probability.

### BACKGROUND

Service quality as perceived by customers is an important aspect of the telecommunications industry. To successfully maintain and enhance the service quality to customers, network behaviors require measurement and analysis. However, measuring and improving a customer's quality of service (QoS) experience remains a challenging task, which requires accounting for technical issues, such as response times and throughput, and non-technical issues, such as customer expectations, prices and customer support. One mechanism to measure these issues is by root cause analysis for network troubleshooting in a communication network. For example, a customer service assurance platform may be used to analyze performance and quality degradation from a variety of network services, such as content servers and user devices, to ensure customer service quality is consistent with communication service provider expectations.

Another mechanism to troubleshoot communication networks involves use of Key Performance Indicators (KPIs) and Key Quality Indicators (KQIs). KQIs and KPIs are typically measured in an effort to determine various performance levels of the network services such that an operator may detect any deterioration (degradation) of service levels as well as to identify the cause(s) associated with the deterioration in service level. For example, a user's device may experience poor coverage or fail to handover due to a faulty base station or a content server may suffer from a hardware issue resulting in performance degradation. However, while measurement of performance levels using KPIs may be accomplished in a relatively fast and economic manner, it is often time consuming and costly to properly measure and calculate KQIs. As a result, QoS performance levels may not be readily identifiable.

### BRIEF SUMMARY

In one embodiment, there is a method for determining a root cause of anomalous behaviors in a network, comprising categorizing each of one or more first indicators into a corresponding one of a plurality of first groups and each of one or more second indicators into a corresponding one of a plurality of second groups; estimating a conditional probability by calculating a probability that the one or more second indicators will result in a degradation of one of the first indicators based on historical data of the one or more first and second indicators using association rule learning; mapping the one or more second indicators having the conditional probability associated with degradation of the one of the first indicators to a corresponding one of the plurality of first groups (in a probabilistic network structure based on a detected degradation of the one of the first indicators in the historical data; and determining whether the one or more second indicators mapped to the corresponding one of the plurality of first groups satisfies a threshold when degradation of the one of the first indicators is detected, and ranking each of the one or more second indicators that results in the degradation of the one of the first indicators according to a corresponding conditional probability.

In another embodiment, there is a non-transitory computer-readable medium storing computer instructions for determining a root cause of anomalous behavior in a network, that when executed by one or more processors, perform the steps of: categorizing each of one or more first indicators into a corresponding one of a plurality of first groups (states) and each of one or more second indicators into a corresponding one of a plurality of second groups; estimating a conditional probability by calculating a probability that the one or more second indicators will result in a degradation of one of the first indicators based on historical data of the one or more first and second indicators using association rule learning; mapping the one or more second indicators having the conditional probability associated with degradation of the one of the first indicators to a corresponding one of the plurality of first groups in a probabilistic network structure based on a detected degradation of the one of the first indicators in the historical data; and determining whether the one or more second indicators mapped to the corresponding one of the plurality of first groups satisfying a threshold when degradation of the one of the first indicators is detected, and ranking each of the one or more second indicators that results in the degradation of the one of the first indicators according to a corresponding conditional probability.

In still another embodiment, there is a device for determining a root cause of anomalous behavior in a network, comprising: a non-transitory memory storing instructions; and one or more processors in communication with the non-transitory memory, wherein the one or more processors execute the instructions to: categorize each of one or more first indicators into a corresponding one of a plurality of first groups and each of one or more second indicators into a corresponding one of a plurality of second groups; estimate a conditional probability by calculating a probability that the one or more second indicators will result in a degradation of one of the first indicators based on historical data of the one or more first and second indicators using association rule learning; map the one or more second indicators having the conditional probability associated with degradation of the one of the first indicators to a corresponding one of the plurality of first groups in a probabilistic network structure based on a detected degradation of the one of the first indicators in the historical data; and determine whether the one or more second indicators mapped to the corresponding one of the plurality of first groups satisfies a threshold when degradation of the one of the first indicators is detected, and rank each of the one or more second indicators that results in the degradation of the one of the first indicators according to a corresponding conditional probability.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures for which like references indicate elements.

FIG. 1 illustrates a cellular communication system in accordance with one embodiment.

FIG. 2 illustrates an example system for processing and analyzing data sets.

FIG. 3 illustrates a Bayesian network for determining root cause for degradation in accordance with one embodiment.

FIG. 4 illustrates categorizing and processing of data sets to generate association rules.

FIG. 5 illustrates a pattern detection table in accordance with one embodiment.

FIGS. 6A and 6B illustrate graph charts representative of the data in the table of FIG. 5.

FIG. 7 is a flow diagram for determining a root cause of anomalous or degraded behavior in a network.

FIG. 8 illustrates a flow diagram illustrating the collection and quantization of data sets.

FIG. 9 illustrates a flow diagram of constructing a data tree in accordance with FIG. 4.

FIG. 10 illustrates a flow diagram of traversing a probabilistic network structure to predict root causes in accordance with FIG. 3.

FIG. 11 illustrates a block diagram of a network system that can be used to implement various embodiments.

### DETAILED DESCRIPTION

The disclosure relates to technology for determining a root cause of anomalous behavior in a network using a probabilistic network structure (learned network), such as a Bayesian network or finite state machine.

Determining the cause of anomalous or degraded behavior in a network (e.g., network slowness) for a particular transaction, component, entity, etc. can be onerous. The technology described herein determines or infers probable root causes of degradation in network transactions using learned networks. In some embodiments, the learned network may be updated to reflect the dynamically evolving environment of the network or based on specific operator feedback.

To determine root causes within the network, data from network transactions, components, entities, etc. are collected and measured using, for example, monitoring agent and sensors located throughout the network. The collected and measured data includes, for example, quality of service (KQI) and performance (KPI) level indicators, which may be categorized and labeled into various states (e.g., good, bad, very bad, etc.). Conditional probabilities between states of KQIs and KPIs may then be estimated from historical data sets (e.g., historical KQI and KPI data). For each KQI anomaly that is detected in the network, an associated one or more KPI values are mapped to the states in the learned network. The associated one or more KPIs are ranked according to a corresponding conditional probability and used to determine a potential root cause for the associated degraded KQI.

It is understood that the present embodiments of the invention may be implemented in many different forms and that claims scopes should not be construed as being limited to the embodiments set forth herein. Rather, these embodiments are provided so that this disclosure will be thorough and complete and will fully convey the inventive embodiment concepts to those skilled in the art. Indeed, the invention is intended to cover alternatives, modifications and equivalents of these embodiments, which are included within the scope and spirit of the invention as defined by the appended claims. Furthermore, in the following detailed description of the present embodiments of the invention, numerous specific details are set forth in order to provide a thorough understanding. However, it will be clear to those of ordinary skill in the art that the present embodiments of the invention may be practiced without such specific details.

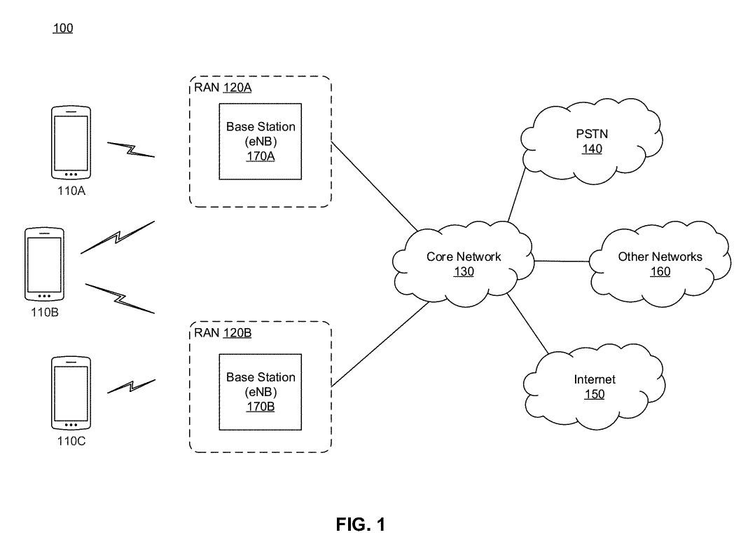

FIG. 1 illustrates a wireless network for communicating data. The communication system 100 includes, for example, UE 110A-110C, radio access networks (RANs) 120A-120B, a core network 130, a public switched telephone network (PSTN) 140, the Internet 150, and other networks 160. While certain numbers of these components or elements are shown in the figure, any number of these components or elements may be included in the system 100.

System 100 enables multiple wireless users to transmit and receive data and other content. The system 100 may implement one or more channel access methods, such as but not limited to code division multiple access (CDMA), time division multiple access (TDMA), frequency division multiple access (FDMA), orthogonal FDMA (OFDMA), or single-carrier FDMA (SC-FDMA).

The UEs 110A-110C are configured to operate and/or communicate in the system 100. For example, the UEs 110A-110C are configured to transmit and/or receive wireless signals or wired signals. Each UE 110A-110C represents any suitable end user device and may include such devices (or may be referred to) as a user equipment/device (UE), wireless transmit/receive unit (WTRU), mobile station, fixed or mobile subscriber unit, pager, cellular telephone, personal digital assistant (PDA), smartphone, laptop, computer, touchpad, wireless sensor, or consumer electronics device.

In the depicted embodiment, the RANs 120A-120B include base stations 170A, 170B (collectively, base stations 170), respectively. Each of the base stations 170 is configured to wirelessly interface with one or more of the UEs 110A, 110B, 110C (collectively, UEs 110) to enable access to the core network 130, the PSTN 140, the Internet 150, and/or the other networks 160. For example, the base stations (BSs) 170 may include one or more of several well-known devices, such as a base transceiver station (BTS), a Node-B (NodeB), an evolved NodeB (eNB), a Home NodeB, a Home eNodeB, a site controller, an access point (AP), or a wireless router, or a server, router, switch, or other processing entity with a wired or wireless network.

In one embodiment, the base station 170A forms part of the RAN 120A, which may include other base stations, elements, and/or devices. Similarly, the base station 170B forms part of the RAN 120B, which may include other base stations, elements, and/or devices. Each of the base stations 170 operates to transmit and/or receive wireless signals within a particular geographic region or area, sometimes referred to as a “cell.” In some embodiments, multiple-input multiple-output (MIMO) technology may be employed having multiple transceivers for each cell.

The base stations 170 communicate with one or more of the UEs 110 over one or more air interfaces (not shown) using wireless communication links. The air interfaces may utilize any suitable radio access technologies.

It is contemplated that the system 100 may use multiple channel access functionality, including for example schemes in which the base stations 170 and UEs 110 are configured to implement the Long Term Evolution wireless communication standard (LTE), LTE Advanced (LTE-A), and/or LTE Broadcast (LTE-B). In other embodiments, the base stations 170 and UEs 110 are configured to implement UMTS, HSPA, or HSPA+ standards and protocols. Of course, other multiple access schemes and wireless protocols may be utilized.

The RANs 120A-120B are in communication with the core network 130 to provide the UEs 110 with voice, data, application, Voice over Internet Protocol (VoIP), or other services. As appreciated, the RANs 120A-120B and/or the core network 130 may be in direct or indirect communication with one or more other RANs (not shown). The core network 130 may also serve as a gateway access for other networks (such as PSTN 140, Internet 150, and other networks 160). In addition, some or all of the UEs 110 may include functionality for communicating with different wireless networks over different wireless links using different wireless technologies and/or protocols.

In one embodiment, the base stations 170 comprise a carrier aggregation component (not shown) that is configured to provide service for a plurality of UEs 110 and, more specifically, to select and allocate carriers as aggregated carriers for a UE 110. More specifically, the carrier configuration component of base stations 170 may be configured to receive or determine a carrier aggregation capability of a selected UE 110. The carrier aggregation component operating at the base stations 170 is operable to configure a plurality of component carriers at the base stations 170 for the selected UE 110 based on the carrier aggregation capability of the selected UE 110. Based on the selected UE(s) capability or capabilities, the base stations 170 are configured to generate and broadcast a component carrier configuration message containing component carrier configuration information that is common to the UEs 110 that specifies aggregated carriers for at least one of uplink and downlink communications. In another embodiment, base stations 170 generate and transmit component carrier configuration information that is specific to the selected UE 110. Additionally, the carrier aggregation component may be configured to select or allocate component carriers for the selected UE 110 based on at least one of quality of service needs and bandwidth of the selected UE 110. Such quality of service needs and/or required bandwidth may be specified by the UE 110 or may be inferred by a data type or data source that is to be transmitted.

Although FIG. 1 illustrates one example of a communication system, various changes may be made to FIG. 1. For example, the communication system 100 could include any number of UEs, base stations, networks, or other components in any suitable configuration.

It is also appreciated that the term UE may refer to any type of wireless device communicating with a radio network node in a cellular or mobile communication system. Non-limiting examples of a UE are a target device, device-to-device (D2D) UE, machine type UE or UE capable of machine-to-machine (M2M) communication, PDA, iPAD, Tablet, mobile terminals, smart phone, laptop embedded equipped (LEE), laptop mounted equipment (LME) and USB dongles.

Moreover, while the embodiments are described in particular for downlink data transmission scheme in LTE based systems, they are equally applicable to any radio access technology (RAT) or multi-RAT system. The embodiments are also applicable to single carrier as well as to multicarrier (MC) or carrier aggregation (CA) operation of the UE in which the UE is able to receive and/or transmit data to more than one serving cells using MIMO.

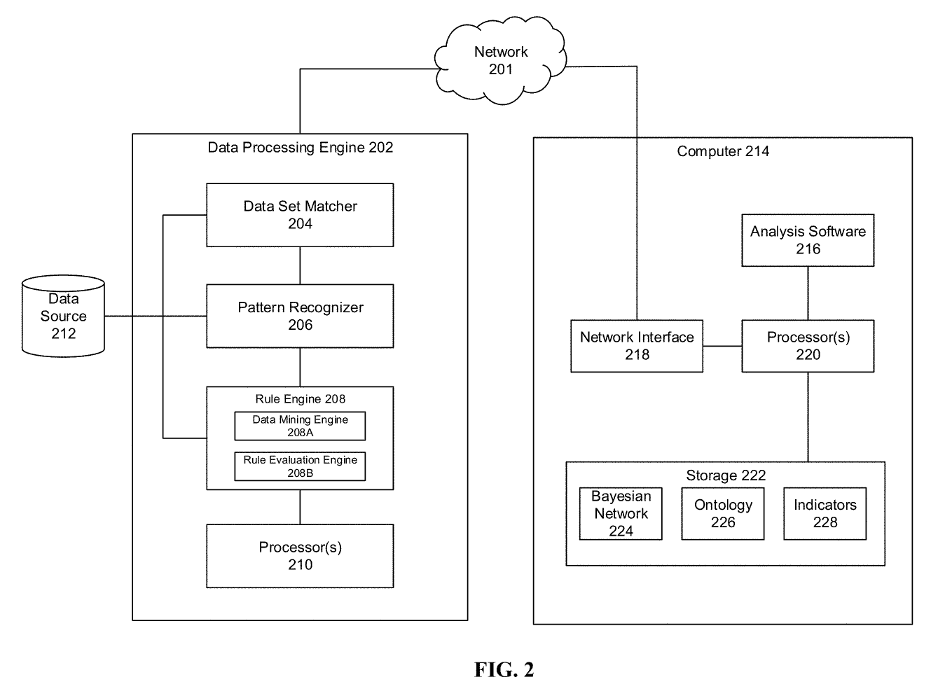

FIG. 2 illustrates an example system for processing and analyzing data sets. The system includes, for example, a data processing engine 202 coupled to a data source 212 (which may be any form of storage or storage system) and a computer 214 coupled to network 201. The system may also include an input device (not shown) where one or more conditions or parameters of the association rules to be mined may be input. For example, the input device may be used to input the threshold conditions (e.g., thresholds for lift, support, confidence, etc., as well as the type of algorithm to implement) for the association rule to be mined. In one embodiment, the system is part of or in communication with the wireless communication network 100 (FIG. 1). Thus, networked base stations 170, UEs 110 and the like may access the data processing engine 202 and computer 214.

The data processing system 202 includes, for example, a data set matcher 204, pattern recognizer 206, rule engine 208 and processor(s) 210. The data set matcher 204 may be included for mapping first data or a first data set to second data or a second data set after the data from each set has been grouped and/or categorized. The data set matcher 204 may also transform groups of data in the data set to provide categories that describe and label the group.

For example, a group of a first data set may include values that demonstrate poor QoS over a defined time period. The group may then be categorized as a “poor” QoS or identified as representing a certain percentage of the QoS (e.g., the poor QoS category represents 5% of the data or data set). Similarly, another group of a second data set may include values that demonstrate poor performance over a defined time period. This group may be categorized as a “poor” performance category or identified as representing a certain percentage of the performance (e.g., the poor performance category represents 10% of the data or data set). The data set matcher 204 may then match or associate or map the data or groups of data having a cell ID (over a time interval) for which the groups have the same categorization (e.g., poor).

The data processing engine 202 may also include a pattern recognizer 206 to identify frequent patterns occurring in the first and second sets of data stored in the data source 212. In the disclosed embodiments, the patterns are recognized from the data and data sets stored in the data source 212. For example, the pattern recognizer 206 may use an apriori algorithm, eclat algorithm or FP-Growth technique to identify frequent patterns in the data stored in the database 212. The detected patterns may, for example, demonstrate a relationship between KQIs and KPIs, as detailed below.

The pattern recognizer 206 may also be responsible for generating frequent patterns for analysis by the rule engine 208, and in particular the data mining engine 208A. However, it is appreciated that the data sets may be generated, and patterns detected, in real-time. Moreover, the data sets may be collected and retrieved from any network component, such as the UEs 110 or base stations 170, and are not limited to collection and storage in the data source 212.

In one embodiment, the pattern recognizer 206 may determine if patterns are becoming more or less frequent over time. For example, applying a shorter time interval for determining pattern frequency generally increases the weighting of recent pattern frequency, but typically lowers the amount of statistical significance to the data. Conversely, using longer time periods for determining pattern frequency yields more statistical confidence in the data, but decreases the accuracy due to the inclusion of older pattern frequency data. Thus, in one embodiment, the pattern recognizer 206 may evaluate different time intervals to recognize different time slices of data generated across the network. Pattern recognition is discussed in more detail below with reference to the various figures.

The rule engine 208 is responsible for generating association rules from the pattern information determined by pattern recognizer 206, and includes a data mining engine 208A and rule evaluation engine 208B (described below). The pattern recognizer 206 may be part of the rule engine 208 and/or implemented independently (as depicted). Thus, in one embodiment, the database 212 may be connected to rule engine 208, the pattern recognizer 206 and/or the data set matcher 204. In another embodiment, collected data or data from the database 212 may be matched by the data set matcher 204, passed to the pattern recognizer 206 for processing to identify patterns, and then passed to the rule engine 208 for rule generation.

The data mining engine 208A may implement one or more data mining functions or algorithms that analyze data to produce the data mining models. For example, similar to the pattern recognizer 206, the data mining engine 208A may also utilize a data mining association rules algorithm, such as the apriori, eclat and FP-growth algorithms, to generate data rules from the data sets. The data mining engine 208A may also be implemented using any well-known techniques, and is not limited to implementation of the aforementioned algorithms.

In one embodiment, the algorithms may produce association rules models as defined in the predictive model markup language (PMML) standard. The association rule model represents rules where some set of data is associated to another set of data. For example, a rule can express that a certain QoS (KQI) level often occurs in combination with a certain set of performance (KPI) levels. For example, the association algorithm may receive as an input cell identifiers (IDs) (and associated timestamps) along with corresponding KQI and KPI values. The association algorithm may then search for relationships between the KQI at each cell ID and the KPIs at the associated timestamps.

The data mining engine 208A then uses the association rule algorithm to generate data rules that satisfy the specified metrics, such as lift, support and confidence.

The generated data rules may then be loaded to a rule evaluation engine 208B which executes the rules against selected tables and records from the data source 212, capturing results and analysis. That is, the data records in the data source 212 may be processed by the rule evaluation engine 208B applying the data rules to determine data records that have values that deviate from the values that are expected by the rules.

The computer 214 includes analysis software 216, network interface 218, processor(s) 220 and storage 222, including Bayesian network 224, ontology 226 and indicators 228 that may be stored therein. The analysis software 216 may analyze the data received from the data source 212 and/or data processing engine 202 via network 201. The data may include, for example, any data useful in analyzing quality of service and performance levels in the network 100, such indicators 228 (e.g., KQIs and KPIs).

The analysis software 214 may be executable by the processor(s) 220, which is (are) connected through a network interface 218 to the network 201 to allow the computer 214 to communicate over the network 201. Although shown as a single block, it is understood that the computer 214 can refer to either a single computer node or to multiple computer nodes.

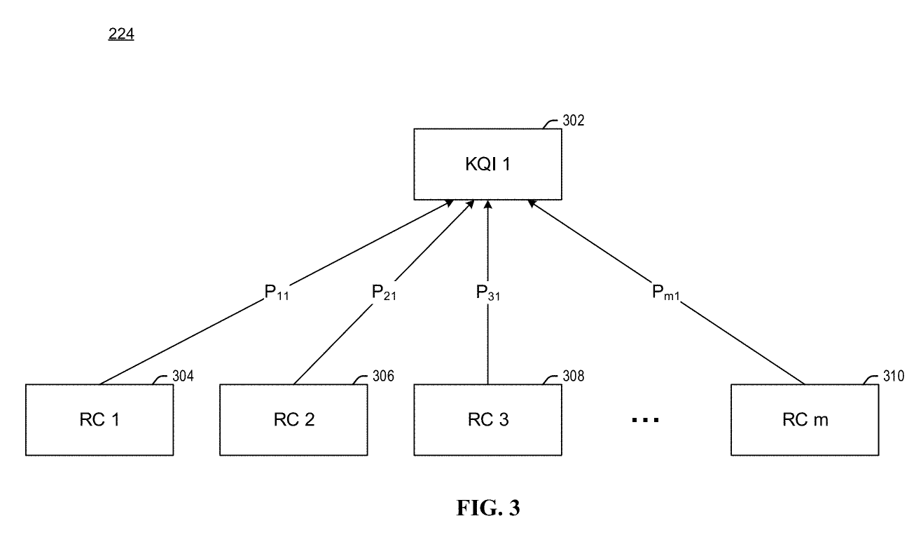

The analysis software 216 implements the association rule learning referred to above and analyzes the data associated with network entities to construct a probabilistic network structure or tree, such as Bayesian network 224 (defined further below with respect to FIG. 3), that identifies relationships between the data in the network 100. In one embodiment, the constructed Bayesian network 224 is stored in the storage 222. It is appreciated that although the Bayesian network 224 and analysis software 216 are shown as separate elements, the Bayesian network 224 may be formed as part of the analysis software 216. Moreover, the Bayesian network 224 may continually update its model (expressed as a structure or tree) of the network 100 based on continued receipt of data over time.

The analysis software 216 may also be executed to construct inferences based on the frequency of data and recognized patterns as elicited, for example, from pattern recognizer 206. In one embodiment, the relationships between data and data sets can be inferred from the frequency and occurrence of the data as detected by sensors and/or monitoring agents throughout the network 100.

In addition, to assist in constructing the Bayesian network 224, an ontology (or data tree or data structure) 226 may also be created and stored in the storage 222. The ontology is a structured, machine-readable data model. The ontology 226 models the concepts of the domain being analyzed, in this example the network 100. The ontology 226 forms a structure between data collected from the domain or network (and relationships between the data, such as the KQIs and KPIs). The ontology 226 may then serve as a structure detailing the network to enable the construction of the Bayesian network 224.

In the process of learning the Bayesian network 224, analysis is performed of the frequency of the incoming data or indicators 228, which may be categorized into groups, over a period of time. Based on the analyzed indicators 228, the Bayesian network 224 is able to determine the likelihood that different indicators 228 are related and also determine the type of relationship (e.g., whether it is a cause or an effect relationship). For example, what is the relationship between a KPI and a KQI such that when the KPI occurs a degradation in the KQI also occurs.

It is also appreciated that while data processing engine 202 and computer 214 are illustrated as separate network components, they may reside on the same component or device.

Once the Bayesian network 224 is trained (learned), the Bayesian network 224 can be used to make predictions. For example, the Bayesian network 224 can predict if an indicator such as KPI will impact the quality of an associated KQI, as discussed below. As will be further explained below, the Bayesian network 224 may be learned from data obtained from association analysis (although learning is not limited to such analysis).

FIG. 3 illustrates a Bayesian network for determining root cause (RC) degradation in accordance with one embodiment. The Bayesian network 224 (which may be stored in storage 222 of FIG. 2) may be created, for example, using the system of FIG. 2 and the association analysis detailed with reference to FIG. 4 below. In the depicted embodiment, the Bayesian network 224 (also known as a probabilistic network, belief network or casual network) structure is, in one embodiment, as a probabilistic finite state machine (PFSM).

In general, Bayesian networks 224 are graphical models for reasoning under uncertainty, where the nodes represent variables (discrete or continuous) and arcs (links) represent direct connections between them. These direct connections are often causal connections. In addition, Bayesian networks model the quantitative strength of the connections between variables, allowing probabilistic beliefs about them to be updated automatically as new information becomes available. Additionally, a Bayesian network is a graphical structure that represents a domain. The nodes in a Bayesian network represent a set of random variables, X=X1, . . . Xi, . . . Xn, from the domain. A set of directed arcs (or links) connects pairs of nodes, Xi→Xj, representing the direct dependencies between variables. Assuming discrete variables, the strength of the relationship between variables is quantified by conditional probability distributions associated with each node.

With reference to the figure, the Bayesian network 224 learns the stochastic properties of the domain, for example, on a continual and real-time basis to update a model of the domain over time, and has a directed acyclic graph (DAG) structure, where the DAG in this example has nodes (e.g., nodes 302, 304, 306, 208 and 310) that represent the variables (e.g., KQI 1, RC 1, RC 2, RC 3 . . . RC m) and arcs (or links) (e.g., P₁₁, P₂₁, P₃₁ . . . Pₘ₁) between the nodes represent conditional dependencies or probabilities between the variables. As expressed above, the links of the Bayesian network 224 are also associated with conditional probability distributions over the variables, where the conditional probability distributions encode the probability that variables assume different values given values of parent variables in the graph. In accordance with some embodiments, the domain is a communication network environment, such as communication network 100 in FIG. 1, having network entities that are associated with events, such as degradation or abnormal events.

Root causes (RCs) may be determined using the Bayesian network 224. That is, the likelihood that any one or more RC results in degradation to a specific node in the structure (e.g., KQI or group of KQIs) may be determined by analyzing the Bayesian network 224. The RC(s), such as RC 1 RC 2, RC 3 . . . RC m, may be represented by one or more KPIs such that for any detected KQI anomaly (degradation), the RCs (KPIs) may be mapped to the anomalous KQI or group of KQls based on the determined conditional probabilities. In one embodiment, the probability that KPIᵢ will result in degradation of KQIⱼ is learned from historical data sets (e.g., data previously learned from or input into the system). For example, assume KPIᵢ occurs five times in the historical data set over a specific time interval. If, out the five occurrences, KPIᵢ results in degradation of KQIⱼ three times, then the probability that KPIᵢ is the RCᵢ of the degradation will be sixty percent (3/5=0.6).

To create the Bayesian network 224, and in accordance with the system described above with reference to FIG. 2, the states of various system behavior, transactions, components, entities, etc. (for example, as represented by the KPIs and KQIs) are classified or categorized, as explained in more detail below. Any one or more algorithms may be employed to infer system state. There are numerous such algorithms, including but not limited to, exact inference algorithms, anytime Bayesian network inference algorithms, approximate inference algorithms, stochastic simulation algorithms, model simplification methods, loopy believe propagation, etc.

In some embodiments, various anomaly detection techniques are employed to determine state. In some cases, for instance, measured KQI and/or KPI values are categorized to states such as “Very good,” “Good,” “Normal,” “Bad” and “Very bad” based on, for example, thresholds set by corresponding anomaly detection algorithms. Additionally, states may be measured at prescribed times or intervals. While the states being classified in the examples provided herein are related to KQI and KPI detection, the system states are not limited thereto and may also correspond to transactions, components and/or entities (or any other network resource or element) associated under evaluation.

In one non-limiting example, the detection of anomalous or abnormal behavior is measured and collected over predefined time intervals. For example, the communication system 100 may detect outliers in data being transmitted within the network that exceeds an interval of time (e.g., 5 ms). As appreciated, techniques other than time-based detection may be implemented. For example, similar techniques for detecting anomalies in KPIs may be employed to determine states of network components, entities, transactions and the like. In one example, user equipment 110 (e.g., a mobile device) transacts with a base station 170 to access a social media site via Internet 150. During the transactions between the user equipment 110 and the base station 170, the system determines that the transactions have a normal traffic flow (does not exceed the threshold) for sixty percent (60%) of the transactions, and a slow traffic flow (exceeds the threshold) for forty percent (40%) of the transactions. In this case, the slowness of a transaction would be inferred as an outlier as determined, for example, by an outlier detection algorithm, and the slow state of the transactions would be categorized for example as “bad” or “very bad.”

Once the states of the data (in the example above, the transaction data) are categorized (as explained further below), the Bayesian network 224 may be constructed. The process of constructing the Bayesian network 224 may be performed, for example, by analysis software 216 and processor(s) 220 (FIG. 2). More specifically, the categorized data sets are mapped to the network topology to learn the Bayesian network 224 to be extracted. Next, the mapped data sets are provided to the analysis software 216 and Bayesian network 224 to continue to learn the Bayesian network 224. By employing these techniques, as noted above, cause and effect relationships (or spatial relationships) may be predicted among anomalies (or abnormalities) associated with corresponding transactions, components, entities, etc. of the network environment.

The process can be recursively repeated to continually update the Bayesian network 224 as conditions change or as the infrastructure of the communication network 100 changes or evolves (e.g., network entities added, removed, upgraded, etc.). In this manner, the model of the communication network 100 may be regularly updated.

FIG. 4 illustrates the categorization and processing of data sets to generate association rules. In the description that follows, the data processing engine 202 may implement the procedures. The data processing engine 202 may be an independent component on the network or included as part of any network component. For example, the data processing engine 202 may be part of the base station 170, UE 110 or any other component. Moreover, the implementation is not limited to implementation by the data processing engine 202. For example, any network component (such as those depicted in FIGS. 1, 2 and 11) may be responsible for implementing the disclosed procedures.

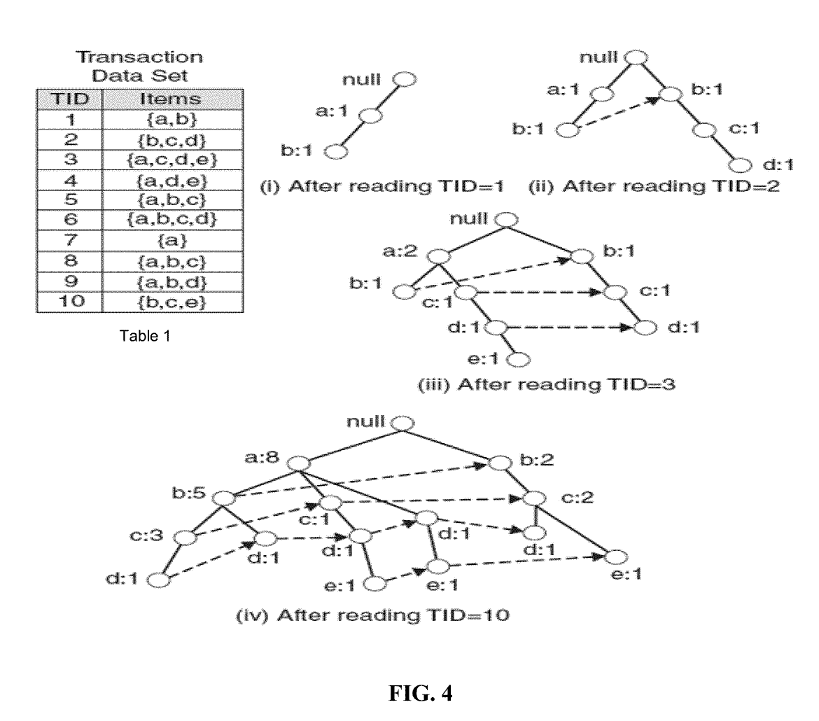

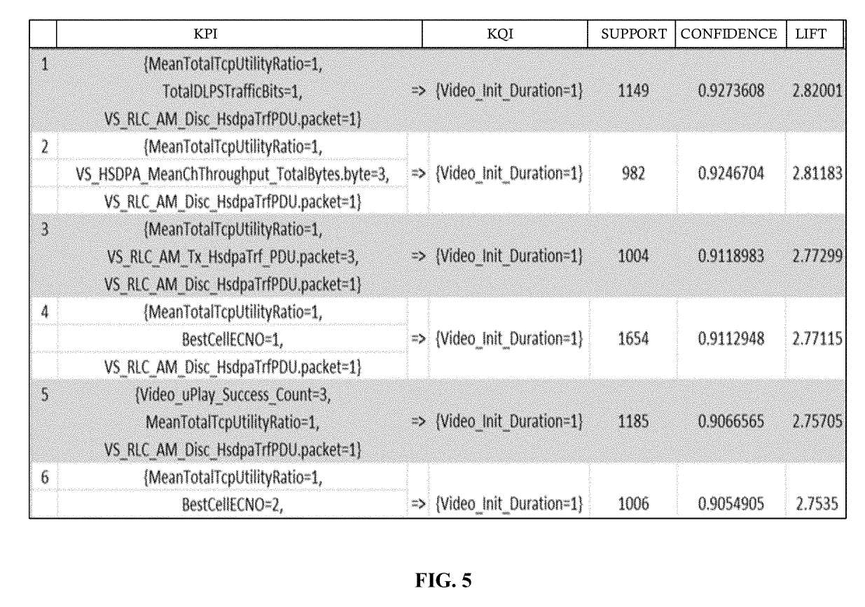

Various resource types (e.g., throughput per location), and associated metrics (e.g., a numerical value or a percentage etc.) are examples of data sets received that may be used to calculate KPIs and KQIs in order to provide an understanding of the current network performance. These data sets (e.g., KQI and KPI data sets) are received, for example, by the data processing engine 202. The calculated KQI data set may include various QoS indicators, such as Video_Init_Duration (FIG. 5). The calculated KPI data set may include various performance indicators, such as MeanTotalTcpUtilityRatio, TotalDLPSTrafficBits and RLC_AM_Disc_HsdpaTrfPDU.packet (FIG. 5). The collection and labeling of the KQI and KPI values that forms the data sets is described in more detail below with reference to FIG. 8.

Once the data has been collected and labeled, a compact data structure or ontology, such as a frequent pattern (FP)-tree, may be generated. As will become apparent below, the FP-tree may be a rare item FP-tree, in one embodiment. For example, the data processing engine 202 mines the collected data sets from transaction data (e.g., web-based transactions) that has occurred over the communication system 100. The collected data sets, such as transaction data set (Table 1), includes a transaction index (TID) and corresponding item list. Each transaction in Table 1 may represent a sequence of items, such as items purchased as part of a web-based transaction, wherein each item of the transaction is represented by a unique item. In the example, of FIG. 4, and for ease of discussion, transactions are represented by the TID and an item associated with the transaction is represented by a letter, such “a” or “b,” Thus, in Table 1, when TID=1, there are two items {a, b} associated with the transaction. However, it is appreciated that the items may be represented using alternative methods. For example, the items may be represented using service and performance indicators.

The data mining engine 208A, for example under the control of processor 210, may use content-based partitioning to begin scanning the collected data sets, such as the transaction data set in Table 1, to determine frequent items based on, for example, a defined threshold, Each transaction of the transaction data set is scanned and the number of times that each item occurs in the scan is counted. Using the TID and count for each item, a table (Table 2, below) may be created for the frequent items that meet the threshold based on the scan of the transaction data set.

In Table 2, frequent items are ordered according to the frequency of occurrence for each item. The ordering may be used to create the Table 2 and a corresponding data structure. More specifically, after scanning the transaction data set, the Table 2 identifies the frequent items. In the example associated with FIG. 4, item A occurs eight (8) times, item B occurs seven (7) times, item C occurs six (6) times, item D occurs five (5) times, and item E occurs three (3) times, as follows.

TABLE 2

| Item | Count |
|---|---|
| A | 8 |
| B | 7 |
| C | 6 |
| D | 5 |
| E | 3 |

After creation of Table 2, the frequent items may be used to build compact data structure (or ontology), such as an FP-tree. For this example, items A-E are identified as items to be used in building the FP-tree. In one embodiment, the FP-tree uses transaction data sets that are associated with a least one rare item. That is, only transaction data sets that include a rare item will be used to create the FP-tree. A rare item may be an item that occurs infrequently and/or may be classified as such during the categorization of KQI and KPI values, as described above. In one example, items classified in a certain percentile (e.g., the lower 5% or 10%) may be considered rare items. In another example, items classified as “bad” or “very bad” may be considered rare items. It is appreciated that a rare item may be defined in any manner suitable to satisfy a particular threshold and is not limited to above-described embodiments.

The FP-tree is constructed using, for example, processor 210 (or any other processing component) from a root node (in the depicted example, “null”) using the frequent items A-E in Table 2. According to one embodiment, the five identified frequent items that correspond to the ten TIDs are used to build the compact data structure. In the example of FIG. 4, the FP-tree is a representation of the identified frequent items (e.g. A-E) and their transactional relationship to one another in accordance with the occurrence frequency and content. For example, a parent node “a:1” and child node “b:1” correspond to the most frequent item {a,b} associated with TID=1. This is depicted in graph (i) “After reading TID=1.” The next most frequent item {b,c,d}, associated with TID=2, is then evaluated to create the graph depicted in (ii) “After reading TID=2.” Here, parent node “b:1” has child node “c:1” and grandchild node “d:1.” Additionally, the dotted arrow line represents a directed edge between node “b:1” of the first frequent item and “b:1” of the next frequent item. The process of constructing the FP-tree continues for each TID in the table until reaching the final TID (in this case, TID=10). After evaluating TID=10, the FP-tree is completed as illustrated in graph (iv) “After reading TID=10.”

Once the FP-tree has been generated, the data processing engine 202 and/or rule engine 208 apply association rule learning (modeling) to generate data rules and probabilities of occurrence. For example, the association rule learning attempts to find associations, such as common or frequent patterns and trends in the collected data sets. These associations are supported by statistical correlations between different attributes of the dataset and are extracted using an algorithm, such as the bottom-up algorithm. For example, the data rules model a relationship between indicators, such as the KQIs and the KPIs, by predicting pattern frequencies and casual relationships between the KQIs and the KPIs. After rule extraction, rule evaluation metrics may be employed by data processing engine 202 and/or rule engine 208 to calculate, for example, lift, support, and confidence.

Support is a measure of the percentage of task-relevant data transactions for which a rule is satisfied. A task-relevant data transaction as the term is used in the disclosed embodiment, may include for example measurement of KPIs or KQIs. That is, a transaction A may be a measurement of KQIs and a transaction B may be a measurement of KPIs. For example, the support for the rule A→B may be measured by (number of transactions containing both A and B)/(number of total transactions) or by the equation:

$$Support = \frac{count ( A ⋂ B )}{count ( D )} ,$$

where D is the entire data set (total transactions). Thus, the support for the rule A→B may be a measure of (number of measurements containing both KQI and KPI)/(number of total measurements).

Confidence is the measure of certainty or trustworthiness associated with each discovered pattern. For example, the confidence for the rule A→B may be measured by (number of transactions containing both A and B)/(number of transactions containing A) or by the equation:

$$Confidence = \frac{count ( A ⋂ B )}{count ( A )} .$$

Thus, the confidence for the rule A→B may be a measure of (number of measurement containing both KQI and KPI)/(number of measurements containing KQI).

Lift is a measure of the probability of a transaction occurring divided by the probability that an event occurs. For example, the lift for the rule A→B may be measured by ((number of transactions containing both A and B)/(number of transactions containing A))/((number of transactions containing B)/(total number of transactions)) or by the equation (504):

$$Lift = \frac{P ( A ⋂ B )}{P ( A ) P ( B )} .$$

Thus, the lift for the rule A→B may be a measure of ((number of measurements containing both KQI and KPI)/(number of measurements containing KQI))/((number of measurements containing KPI)/(total number of measurements)).

Using the calculated support, confidence and lift, the data processing engine 202 may predict the probability that one or more KQIs is likely to be degraded based on one or more associated KPIs from the determined rules and used, for example, to map KPIs to KQIs in the aforementioned Bayesian network 224. An example of rules learned by the association rule learning is described in more detail below with reference to FIG. 5.

FIG. 5 illustrates a pattern detection table in accordance with one embodiment. The detected patterns are a result of the evaluation and analysis of collected data sets, as described above. The illustrated example shows pattern detection for a KQI labeled as “Video_Init_Duration=1.” The KPI data selected in the column labeled (“KPI”) is a list of the KPI data selected to predict KQI data based on the KPIs identified in the compact data structure. For example, the KPI and KQI columns are generated based on the associations learned from the rule extraction. In this case, assuming a transaction data set of 200 cells in a communication network, it has been determined by association rule learning that three KPIs (in one example, MeanTotalTcpUtilityRatio (KPI1), TotalDLPSTrafficBits (KPI2) and VS_RLC_AM_Disc_HsdpaTrfPDU.packet (KPI3)) result in a degradation of a KQI (Video_Init_Duration). Based on the association rule learning, the support (1149), confidence (0.9273608) and lift (2.82001) may be calculated using the respective formulas expressed above. Additionally, and as a result of the association rule learning, the following rules may be obtained:
When: MeanTotalTcpUtilityRatio (KPI 1)≧0.84;
TotalDLPSTrafficBits (KPI2)≧0.57 Mb; and
VS_RLC_AM_Disc_HsdpaTrfPDU.packet (KPI3)≧1.7 k,
Then: Video_Init_Duration (KQI) is HIGH (i.e., >4.91 s).

The various thresholds (e.g., 0.84, 0.57 Mbs and 1.7 k) for each of the KPIs may be pre-defined by an operator of the communication system or learned by a machine learning algorithm, such as the FP-growth algorithm. In one example, thresholds may be determined during quantization when categorizing KQI and KPI values into different groups.

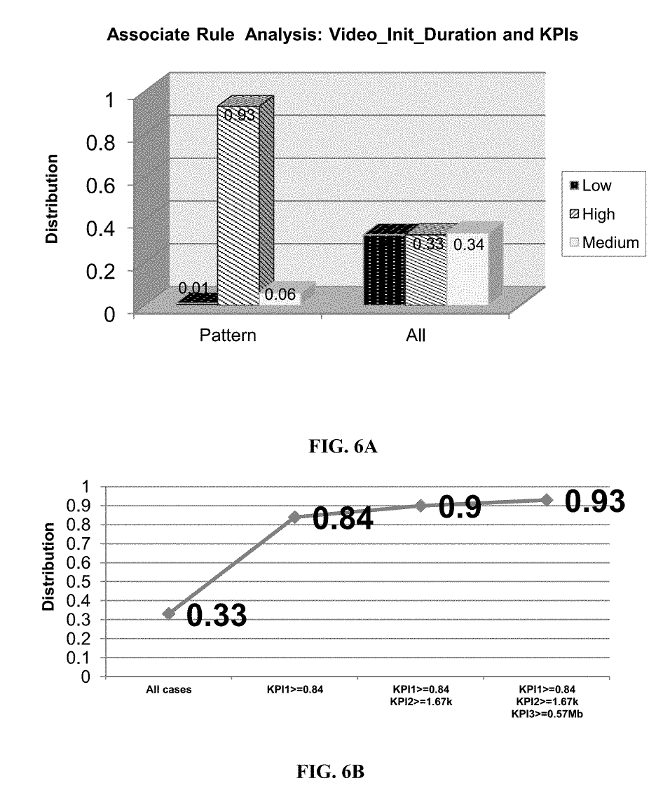

FIGS. 6A and 6B illustrate graph charts representative of the data in the table of FIG. 5. The bar graph illustrated in FIG. 6A, while applying the example data of FIG. 5, shows the probability that one or more KQI (Video_Init_Duration) has been degraded as a result of the associated KPIs. More specifically, the vertical axis (y-axis) shows the distribution of probability that the associated KPIs are the root cause of the degraded KQI. The horizontal axis (x-axis) shows a ranking or labeling (e.g., High, Medium and Low) of the probability for associated KQI and KPIs for which a pattern exists, as well as for all associated KQI and KPIs.

FIG. 6B also shows the probability that one or more KQI (Video_Init_Duration) has been degraded as a result of the associated KPIs. In this case, and applying the example data of FIG. 5, the graph charts the distribution (y-axis) against KPI(s) values compared to one or more thresholds (x-axis) for KPIs. For example, the graph charts the probability that the KPI(s) are the root cause of the KQI degradation for: (a) all KPIs; (b) KPI1≧0.84; (c) KPI1≧0.84 and KPI2≧1.67 k; and (d) KPI1≧0.84, KPI2≧1.67 k and KPI3≧0.57 Mbs. Thus, for (a), the probability that the KPI(s) are the root cause of the degraded KQI is 33%. For (b), the probability that the KPI(s) are the root cause of the degraded KQI is 84%. For (c), the probability that the KPI(s) are the root cause of the degraded KQI is 90%, and for (d) the probability is 93%. Accordingly, the level of certainty that the KPI(s) is the probable root cause of the degraded KQI increases as the number of KPI(s) satisfy the defined thresholds.

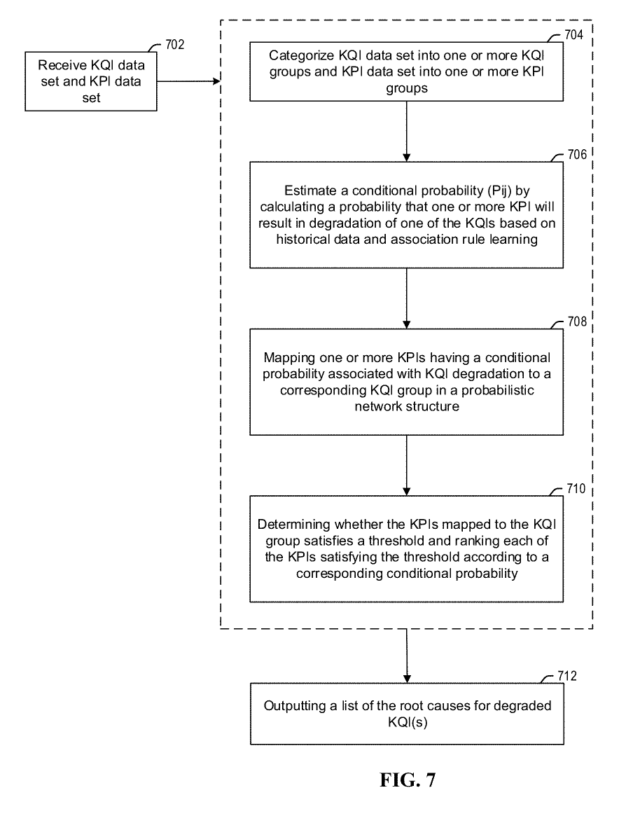

FIG. 7 is a flow diagram for determining a root cause of anomalous or degraded behavior in a network. The following process may be implemented, for example, using the data processing engine 202 and computer 214, along with respective components. At 702, the data sets are received for analysis. The data sets may include a first data set including one or more first indicators (KQIs) indicative of a quality of service associated with a source in the communication network 100, and a second data set including one or more second indicators (KPIs) indicative of a performance level associated with the source in the communication network 100. Additionally, the received data sets may be collected using monitoring agents and sensors placed throughout the communication system 100 or received from a data source, such as data source 212, after having been collected and stored. The data itself may be historical (i.e., past or older data) or received in real-time.

At 704, the data sets (including the KQI and KPI data) are categorized into one or more KQI and KPI groups, respectively, and the conditional probability P_{Ij}, i.e., the probability that RCᵢ will result in the degradation of KQIⱼ from the historical data sets using the association rule learning (described above) is estimated at 706, where RCᵢ is defined as KPI_{I}ε[tₗⁱ, tᵤⁱ], and which may be expressed mathematically as:

Pᵢⱼ=P(KQIⱼε[dₗ^{j},dᵤ^{j}]|KPIᵢε[tₗⁱ,tᵤⁱ]),

where dₗ^{j}, dᵤ^{j}, tₗ^{j}, tᵤ^{j}, are pre-defined thresholds or learned by a machine learning algorithm. It is also appreciated that the thresholds may be time-varying (e.g., different for different time slots) and vary for different cells in the communication network 100.

Once the conditional probabilities have been estimated at 706, the system maps the KPI(s) to the KQI(s). In one embodiment, the mapped data sets are provided to the analysis software 216 and Bayesian network 224 to continue learning. Thus, the mapping of KPIs to KQIs enables the system to construct the Bayesian network 224 that illustrates the KPI(s) having a conditional probability associated with a degraded KQI, as described above.

In the event of KQI performance degradation in the communication system 100, the KPI(s) corresponding to the degraded KQI is checked to determine whether it is a potential root cause. In making this determination, the KPI(s) mapped to the KQI(s) are evaluated to determine whether each KPI satisfies the threshold (as discussed above) at 710. Each KPI satisfying the threshold requirement is then ranked according to a corresponding conditional probability (Pᵢⱼ). At 712, a list of the root causes is output for the degraded KQI(s) based on the conditional probability associated with each of the KPI(s) satisfying the threshold. Thus, the system not only provides the root causes for KQI degradation, but also provides the probability associated with each root cause.

FIG. 8 is a flow diagram illustrating the collection and quantization of data sets. At 802, the received KQI and KPI data are collected, for example, over a time series, comprising individual time intervals. In one embodiment, an element management system (EMS) (not shown) collects the data characteristic of the network performance from a base station 170 and performs calculations to obtain the statistical data characterizing the network performance. It is appreciated, however, that any network component may collect the data characteristic of network performance, and that such collection is not limited to the EMS. For example, the base station 170 or UE 110 may also be responsible for such collection. Such data characteristic of the network performance includes data related to telephone traffic, data related to neighbor relationship, data related to coverage, or the like. In another embodiment, the EMS indirectly calculates UE 110 service experience data and performance statistical data from data directly reported by the UE 110, data characteristic of the network performance forwarded through the base station 170 or data characterizing the network performance reported by the base station 170.

In one embodiment, the KQI and KPI data sets are processed and categorized into one or more KQI groups and KPI groups. In one instance, groups may be formed by quantizing the data at 804. For example, KPIs may be categorized into one of the following: network accessibility, call retainability, device mobility, network capacity, etc. KQIs may also be categorized in a similar manner. Once categorized, the KQIs and KPIs may then be grouped into data sets, for example where each group has KQIs or KPIs in a same category(ies).

In another embodiment, the collected data are quantized into groups over the time interval by the data processing engine 202 at 804. In one example of categorizing and grouping the KQI and KPI data, the KQI and KPI data are categorized using their quintile values into specific layers for association rule mining. For example, the KQI data may be divided into bins and set to be 10%, 40% and 100%. For the KPI data, the bins are set to be 5%, 30%, 60% and 100%. Once the KQI and KPI data have been categorized, the KQI and KPI data are grouped. In the example, the KQI data are placed into three groups, namely 0-10 (representing 10%); 10-40 (representing 40%) and 40-100 (representing 100%). The KPI data are placed into four groups, namely 0-5 (representing 5%), 5-30 (representing 30%), 30-60 (representing 60%) and 60-100 (representing 100%).

The KQI and KPI groups are then labeled into respective categories based on the quantization. For example, a first KQI group may be labeled as “very bad” (5%). KPIs that occur during the time interval of KQI with a label of “very bad” will be used for association by the association rule learning to generate the data rules.

FIG. 9 illustrates a flow diagram of constructing a data tree in accordance with FIG. 4. At 902, a compact data tree is constructed. The compact data tree is constructed from the data sets, such as the transaction data set in Table 1 depicted in FIG. 4. In one example, the transaction data set includes KQI and KPI data sets. The KQI and KPI data are grouped into different categories. For example, KQI data are divided by percentiles and set to be 10%, 40% and 100%, and KPI data are set to 5%, 30%, 60% and 100%, where each KQI and KPI are an item associated with a corresponding category. As described above, the compact data tree is constructed with data sets that include at least one rare item, such as KPIs categorized as “very bad.”

At 904, frequent items, data rules and associated probabilities may be extracted from the compact data tree by application of the association rule learning, in which frequent items model a co-occurrence of different items and the data rules model a relationship between the KQIs and KPIs based on the associated probabilities.

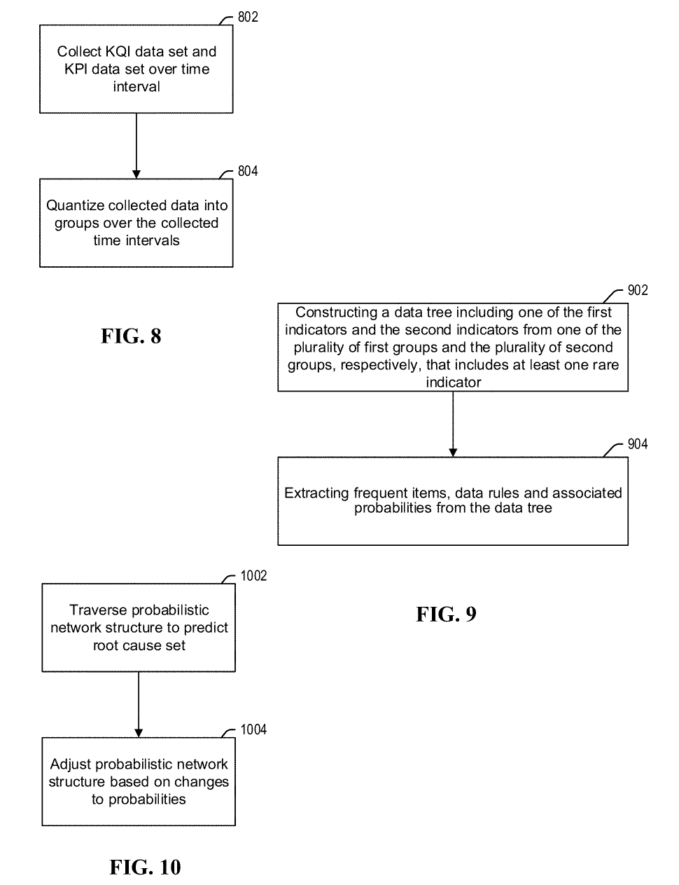

FIG. 10 illustrates a flow diagram of traversing a probabilistic network structure to predict root causes in accordance with FIG. 3. With reference to FIG. 3, a causal Bayesian network 224 represents components and transactions based on a data set. Root cause sets are inferred from the graphical tree constructed from the data set, as described above. That is, at 1002, the Bayesian network 224 is traversed to find nodes and their states to predict or infer root cause(s) from the data set used to the construct the network. For example, for a web-based transaction that is slow, a root cause may be associated with components that were also in an abnormal state based on dependencies inferred by traversing the Bayesian network 224.

In one embodiment, root cause analysis includes identifying KPIs to determine components responsible for KQI degradation. This may be accomplished, in some instances, by detecting spikes or anomalies in component KPIs. Spike detection, for example, may involve KPI measurements from a pre-defined number of intervals and determining whether any particular KPI value has deviated beyond a threshold. In this way, a component with one or more abnormal KPI values may be identified as a root cause of a KQI. In other instances, a detector or sensor in the network may grade or score a KPI value based on a degree of fluctuation from an expected value. For example, components found to have the highest grade or score (i.e., largest degree of fluctuation) during anomaly detection of associated KPIs may be identified as a root cause.

At 1004, adjustments to the Bayesian network 224 may be made (optionally) based on changes in or feedback from the communication system 100. For example, changes in conditional probabilities may provide input to modify the Bayesian network 224. In one embodiment, the network is modified by an operator with comprehensive knowledge of the structure and deployment of the Bayesian network 224. The operator may modify or change dependencies (arcs) and/or edit the node set (e.g., nodes may be added or deleted). Additionally, arc strength may also be input which may, for example, be translated to probability values.

In another embodiment, an application or system component may change or evolve over time in which case the Bayesian network 224 may be updated to reflect the changes. For example, a website for a clothing company may expect a larger volume of transactions during a sale event. In this example, a new component may be provisioned on the communication system 100 to accommodate the larger volume of transactions. As such, the Bayesian network 224 may be modified to create a new dependency between nodes or by allowing the model to continuously learn by utilizing a machine learning algorithm.

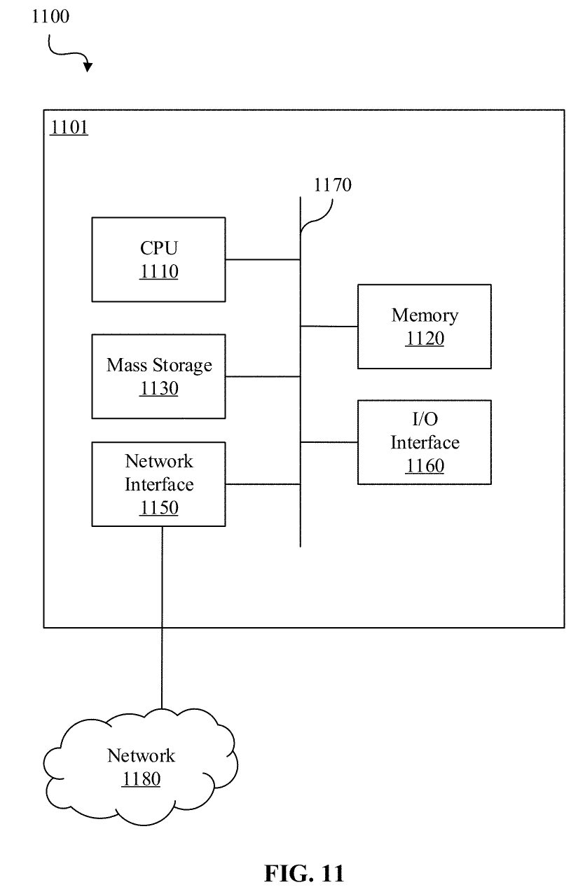

FIG. 11 is a block diagram of a network system that can be used to implement various embodiments. Specific devices may utilize all of the components shown, or only a subset of the components, and levels of integration may vary from device to device. Furthermore, a device may contain multiple instances of a component, such as multiple processing units, processors, memories, transmitters, receivers, etc. The network system 1100 may comprise a processing unit 1101 equipped with one or more input/output devices, such as network interfaces, storage interfaces, and the like. The processing unit 1101 may include a central processing unit (CPU) 1110, a memory 1120, a mass storage device 1130, and an I/O interface 1160 connected to a bus. The bus may be one or more of any type of several bus architectures including a memory bus or memory controller, a peripheral bus or the like.

The CPU 1110 may comprise any type of electronic data processor. The memory 1120 may comprise any type of system memory such as static random access memory (SRAM), dynamic random access memory (DRAM), synchronous DRAM (SDRAM), read-only memory (ROM), a combination thereof, or the like. In an embodiment, the memory 1120 may include ROM for use at boot-up, and DRAM for program and data storage for use while executing programs. In embodiments, the memory 1120 is non-transitory. The mass storage device 1130 may comprise any type of storage device configured to store data, programs, and other information and to make the data, programs, and other information accessible via the bus. The mass storage device 1130 may comprise, for example, one or more of a solid state drive, hard disk drive, a magnetic disk drive, an optical disk drive, or the like.

The processing unit 1101 also includes one or more network interfaces 1150, which may comprise wired links, such as an Ethernet cable or the like, and/or wireless links to access nodes or one or more networks 1180. The network interface 1150 allows the processing unit 1101 to communicate with remote units via the networks 1180. For example, the network interface 1150 may provide wireless communication via one or more transmitters/transmit antennas and one or more receivers/receive antennas. In an embodiment, the processing unit 1101 is coupled to a local-area network or a wide-area network for data processing and communications with remote devices, such as other processing units, the Internet, remote storage facilities, or the like.

There are many benefits to using embodiments of the present disclosure. For example, the disclosed technology generates uses a probabilistic finite state machine approach to model the causality between the causes and the symptoms, provides the causes for KQI degradation and associated probabilities, and is autonomous with an ease of implementation.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the following detailed description of the present subject matter, numerous specific details are set forth in order to provide a thorough understanding of the present subject matter. However, it will be clear to those of ordinary skill in the art that the present subject matter may be practiced without such specific details.

In accordance with various embodiments of the present disclosure, the methods described herein may be implemented using a hardware computer system that executes software programs. Further, in a non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for determining a root cause of anomalous behaviors in a network, comprising
categorizing each of one or more first indicators into a corresponding one of a plurality of first groups and each of one or more second indicators into a corresponding one of a plurality of second groups;
estimating a conditional probability by calculating a probability that the one or more second indicators will result in a degradation of one of the first indicators based on historical data of the one or more first and second indicators using association rule learning;
mapping the one or more second indicators having the conditional probability associated with degradation of the one of the first indicators to a corresponding one of the plurality of first groups in a probabilistic network structure based on a detected degradation of the one of the first indicators in the historical data; and
determining whether the one or more second indicators mapped to the corresponding one of the plurality of first groups satisfies a threshold when degradation of the one of the first indicators is detected, and ranking each of the one or more second indicators that results in the degradation of the one of the first indicators according to a corresponding conditional probability.

2. The method of claim 1, further comprising outputting a list of the root causes for the degraded one of the first indicators based on the conditional probability associated with each of the one or more second indicators satisfying the threshold.

3. The method of claim 1, further comprising receiving a first data set including the one or more first indicators indicative of a quality of service associated with a source in the network, and receiving a second data set including the one or more second indicators indicative of a performance level associated with the source in the network.

4. The method of claim 3, further comprising:
collecting the first data set and the second data set over a time interval; and
quantizing the collected first data set and the second data set to define the first and second groups.

5. The method of claim 1, further comprising:
constructing a data tree including one of the first indicators and the second indicators from one of the plurality of first groups and the plurality of second groups, respectively, that includes at least one rare indicator; and
extracting at least one of frequent items, data rules and associated probabilities from the data tree by application of the association rule learning, wherein the frequent items model a co-occurrence of different items and the data rules model a relationship between the first and second indicators based on the associated probabilities.

6. The method of claim 1, further comprising:
traversing the probabilistic network structure to predict a root cause set associated with degradation of a first indicator, wherein the root cause set comprises one or more of the second indicators; and
adjusting the probabilistic network structure based on changes to the probabilities between the first indicators and one or more of the second indicators.

7. The method of claim 1, wherein the association rule learning is implemented using at least one of a modified FP-growth algorithm and a bottom-up algorithm.

8. The method of claim 1, wherein the conditional probability is defined by
Pᵢⱼ=P(KQIⱼε[dₗ^{j},dᵤ^{j}]|KPIᵢε[tₗⁱ,tᵤⁱ]),
where d and t are pre-defined thresholds.

9. The method of claim 1, wherein the thresholds are time-varying for different time slots.

10. The method of claim 1, wherein the threshold is one of lift, support and confidence.

11. The method of claim 10, wherein the data rules are ranked according to a measured value of at least one of the lift, the support and the confidence, where
$$Lift = \frac{P ( A ⋂ B )}{P ( A ) P ( B )} , \\ Support = \frac{count ( A ⋂ B )}{count ( D )} , and$$
$$Confidence = \frac{count ( A ⋂ B )}{count ( A )} ,$$
where
P is defined as a pattern,
D is defined as a total of the first and second data sets, and
A and B are defined as variables representing data in the first and second data sets.

12. The method of claim 1, wherein the probabilistic network structure is a probabilistic finite state machine.

13. A non-transitory computer-readable medium storing computer instructions for determining a root cause of anomalous behaviors in a network, that when executed by one or more processors, perform the steps of:
categorizing each of one or more first indicators into a corresponding one of a plurality of first groups and each of one or more second indicators into a corresponding one of a plurality of second groups;
estimating a conditional probability by calculating a probability that the one or more second indicators will result in a degradation of one of the first indicators based on historical data of the one or more first and second indicators using association rule learning;
mapping the one or more second indicators having the conditional probability associated with degradation of the one of the first indicators to a corresponding one of the plurality of first groups in a probabilistic network structure based on a detected degradation of the one of the first indicators in the historical data; and
determining whether the one or more second indicators mapped to the corresponding one of the plurality of first groups satisfies a threshold when degradation of the one of the first indicators is detected, and ranking each of the one or more second indicators that results in the degradation of the one of the first indicators according to a corresponding conditional probability.

14. The non-transitory computer-readable medium of claim 13, the one or more processors further performing the step of outputting a list of the root causes for the degraded one of the first indicators based on the conditional probability associated with each of the one or more second indicators satisfying the threshold.

15. The non-transitory computer-readable medium of claim 13, the one or more processors further performing the step of receiving a first data set including the one or more first indicators indicative of a quality of service associated with a source in the network, and receiving a second data set including the one or more second indicators indicative of a performance level associated with the source in the network.

16. The non-transitory computer-readable medium of claim 15, the one or more processors further performing the steps of:
collecting the first data set and the second data set over a time interval; and
quantizing the collected first data set and the second data set to define the first and second groups.

17. The non-transitory computer-readable medium of claim 13, the one or more processors further performing the steps of:
constructing a data tree including one of the first indicators and the second indicators from one of the plurality of first groups and the plurality of second groups, respectively, that includes at least one rare indicator; and
extracting at least one of frequent items, data rules and associated probabilities from the data tree by application of the association rule learning, wherein the frequent items model a co-occurrence of different items and the data rules model a relationship between the first and second indicators based on the associated probabilities.

18. The non-transitory computer-readable medium of claim 13, the one or more processors further performing the steps of:
traversing the probabilistic network structure to predict a root cause set associated with degradation of a first indicator, wherein the root cause set comprises one or more of the second indicators; and
adjusting the probabilistic network structure based on changes to the probabilities between the first indicators and one or more of the second indicators.

19. The non-transitory computer-readable medium of claim 13, wherein the association rule learning is implemented using at least one of a modified FP-growth algorithm and a bottom-up algorithm.

20. The non-transitory computer-readable medium of claim 13, wherein the conditional probability is defined by
Pᵢⱼ=P(KQIⱼε[dₗ^{j},dᵤ^{j}]|KPIᵢε[tₗⁱ,tᵤⁱ]),
where d and t are pre-defined thresholds.

21. The non-transitory computer-readable medium of claim 13, wherein the thresholds are time-varying for different time slots.

22. The non-transitory computer-readable medium of claim 13, wherein the probabilistic network structure is a probabilistic finite state machine.

23. A device for determining a root cause of anomalous behaviors in a network, comprising:
a non-transitory memory storing instructions; and
one or more processors in communication with the non-transitory memory, wherein the one or more processors execute the instructions to:
categorize each of one or more first indicators into a corresponding one of a plurality of first groups and each of one or more second indicators into a corresponding one of a plurality of second groups;
estimate a conditional probability by calculating a probability that the one or more second indicators will result in a degradation of one of the first indicators based on historical data of the one or more first and second indicators using association rule learning;
map the one or more second indicators having the conditional probability associated with degradation of the one of the first indicators to a corresponding one of the plurality of first groups in a probabilistic network structure based on a detected degradation of the one of the first indicators (KQIs) in the historical data; and
determine whether the one or more second indicators mapped to the corresponding one of the plurality of first groups satisfies a threshold when degradation of the one of the first indicators is detected, and rank each of the one or more second indicators that results in the degradation of the one of the first indicators according to a corresponding conditional probability.

24. The device of claim 23, the one or more processors further execute the instructions to output a list of the root causes for the degraded one of the first indicators based on the conditional probability associated with each of the one or more second indicators satisfying the threshold.

25. The device of claim 23, the one or more processors further execute the instructions to:
construct a data tree including one of the first indicators and the second indicators from one of the plurality of first groups and the plurality of second groups, respectively, that includes at least one rare indicator; and
extract at least one of frequent items, data rules and associated probabilities from the data tree by application of the association rule learning, wherein the frequent items model a co-occurrence of different items and the data rules model a relationship between the first and second indicators based on the associated probabilities.

26. The device of claim 23, the one or more processors further execute the instructions to:
traverse the probabilistic network structure to predict a root cause set associated with degradation of a first indicator, wherein the root cause set comprises one or more of the second indicators; and
adjust the probabilistic network structure based on changes to the probabilities between the first indicators and one or more of the second indicators.
